(19) United States
(12) Patent Application Publication
(10) Pub. No.: US 2006/0029804 A1
(43) Pub. Date: Feb. 9, 2006

(54) Continuous flow closed-loop rapid liquid-phase densification of a graphitizable carbon-carbon composite

(76) Inventors: James W. Klett, Knoxville, TN (US); Steven P. Jones, Lake Elizabeth, CA (US)

Correspondence Address: UT-Battelle, LLC;Office of Intellectual Property, One Bethal Valley Road, 4500N, MS-6258, Oak Ridge, TN, 37831, US

(21) Appl. No.: 10/910,482

(22) Filed: Aug. 3, 2004

(51) Int. Cl. B32B 9/00

(52) U.S. Cl. 428/408; 264/489; 264/491; 264/29.5

(57) ABSTRACT

This invention describes materials and methods to rapidly densify carbon-carbon composite preforms utilizing a continuous flow closed-loop liquid precursor.

### STATEMENT REGARDING FEDERALLY SPONSORED RESEARCH

This invention was made with Government support under Contract No. DE-AC05-00OR22725 awarded to UT-Battelle, LLC, by the U.S. Department of Energy. The Government has certain rights in this invention.

### TECHNICAL FIELD

The field of the invention relates to continuous flow closed-loop processes and materials using carbon-carbon composites and liquid precursors.

### DESCRIPTION OF THE BACKGROUND ART

Carbon-carbon (C—C) composites are widely used as friction materials in aircraft braking systems, where their high thermal conductivity, large heat capacity and excellent friction and wear behavior lead to significantly improved aircraft braking performance. Consequently, large commercial aircraft (e.g. Boeing 747, 757, and 767) and all military aircraft utilize carbon-carbon composites in their braking systems. The manufacturing process for carbon-carbon composites is very lengthy, thus carbon-carbon composites are extremely expensive. Two categories of commercial processes have been developed to manufacture carbon-carbon composites such as, fiber-reinforced ceramic matrix and carbon matrix composites. These processes differ principally in the techniques used for the deposition of matrix materials around reinforcing fibers that have already been oriented and positioned into the locations they will occupy in finished products. One technique is vapor-phase in nature and is called “infiltration.” The other is liquid-phase in nature, and is called “impregnation.” Typically, a preform is prepared by hand lay-up of woven carbon fiber fabric, or by hot pressing a mixture of chopped carbon fibers and resin (prepreg). The preform is then densified by repetitive liquid impregnation with pitch or resin or by carbon vapor infiltration, followed by carbonization and graphitization (see Prior Art, FIG. 1). Up to 5 cycles of repeated densification/carbonization can be required to achieve the desired density of 1.8 g/cc, which can take 6 to 9 months. The high cost of carbon-carbon composites has so far restricted the widespread application of these materials to aircraft brakes and other applications that are performance driven, or are relatively cost insensitive. However, the utility of carbon-carbon composites has been demonstrated in the high performance racing vehicle arena. Modern Formula One racing cars use carbon-carbon brakes and clutches because of their significantly improved performance and wear characteristics. These benefits could readily be transferred to the commercial sector if the cost of manufacture could be substantially reduced. Commercial sector applications include clutch and braking systems for heavy trucks, or railroad locomotives and railcars. Moreover, within the military sector there are numerous applications on fighting vehicles (tanks, armored cars, self propelled artillery, etc.) for brakes and clutches.

This invention is a process for the fabrication of carbon-carbon composites that offers potentially large reductions in processing time, allowing finished carbon-carbon composite brake discs to be fabricated in 1-4 weeks, compared to the more usual 24 plus weeks. Commensurate reductions in cost can be realized. The commercial manufacture of carbon-carbon composites has taken place for more than 30 years and is a rather mature field. Both chemical vapor infiltration (CVI) and liquid phase impregnation techniques (or a combination of the two) have been used to place the carbon matrix in the rigidized preform.

During this time the goal has remained the same: to be able to produce a thick (>2″) billet with uniform density at low cost. This objective has not been obtained to date commercially due principally to the matrix precursor employed and the costly impregnation method. Conventional gas phase chemical vapor infiltration processes using hydrocarbon precursors (U.S. Pat. Nos. 4,212,906; 5,061,414; 5,217,657; 5,348,774) are not able to uniformly densify a large-thick billet of complex shape because of the preferential deposition on the outer portion of the billet and the inability to control concentration and temperature gradients in the gas phase. In addition, this family of processes is very expensive due to the expensive equipment and the long processing times required. Attempts to solve the surface deposition problem have involved using a pressure gradient alone (U.S. Pat. No. 5,480,678) or in conjunction with a temperature gradient (hotter on side opposite gas entry) through the part to be densified (U.S. Pat. No. 4,580,524). In addition, a temperature gradient through the part utilizing a heater in the center in conjunction with surface cooling involving a liquids latent heat of vaporization (U.S. Pat. Nos. 4,472,454 and 5,389,152) has been employed. All three approaches have met with some success. However, these techniques are still very costly and limited to relatively small and thin parts with little shape complexity. However, it should be mentioned that the combination of forced flow and a reversed temperature gradient has increased the thickness that can be densified with reasonable uniformity to nearly two inches.

Liquid-phase matrix precursors have included neat organic resins, particulate loaded resins, as well as all types of petroleum and coal tar pitch materials. The patent literature contains many processes that utilize various organic resins (U.S. Pat. Nos. 4,225,569; 5,576,375; 5,686,027; 5,266,695 and 5,192.471), coal tar and petroleum pitch (U.S. Pat. Nos. 5,061,414; 5,217,657; 4,986,943; 5,114,635; 5,587,203 and 4,745,008) solven-trefined pitches (U.S. Pat. No. 4,554,024), particulate loaded resins (U.S. Pat. Nos. 4,041,116; 4,975,261 and 5,009,823), and super-critically-refined pitches (U.S. Pat. No. 4,806,228).

The ability to produce low cost composites with uniform density using liquid-phase carbon precursors has been hindered by the conflicting demands of high char yield and low viscosity. Processes using various organic resins (U.S. Pat. Nos. 4,225,569; 5,576,375; 5,686,027; 5,266,695 and 5,192,471) as well as coal tar and petroleum pitch (U.S. Pat. Nos. 5,061,414; 5,217,657; 4,986,943; 5,114,635; 5,587,203 and 4,745,008) suffer from the fact that these materials have low char yield and high viscosity unless solvated. In addition, these materials do not meet the critical criteria of wetting the fiber preform surface. Processes that involve the use of solvent-refined pitches (U.S. Pat. No. 4,554,024), super-critically-refined pitches (U.S. Pat. No. 4,806,228) and mesophase liquid-crystal polymer (U.S. Pat. Nos. 5,147,588; 5,205,888 and 5,491,000) have increased the char yield but have not addressed the wettability issue, and thus still require many costly processing cycles to produce a composite that is not uniform in density. The use of carbon particulate loaded resins (U.S. Pat. Nos. 4,041,116; 4,975,261 and 5,009,823) again increases the char yield. However, these processes suffer from the same problems as non-loaded resins and in addition are not able to density a thick composite. In fact, they actually produce a lower quality composite because the particles block the pore structure on the first cycle and limit subsequent densification.

One matrix precursor material of choice is a mesophase liquid crystal polymer (U.S. Pat. Nos. 5,147,588; 5,205,888 and 5,491,000) made from petroleum pitch using various proprietary temperature-pressure cycles. In prior processes, the polymerization pathway used to form the matrix precursor of mesophase pitch creates lower quality material. Since the high-char-yield mesophase pitch, for example, is too viscous to use for impregnation and does not wet the preform surface, the preform is impregnated with low-viscosity, low-char-yield isotropic pitch, which is able to wet the preform surface. This pitch is then converted to mesophase pitch inside the preform using various temperature-pressure cycles. The problem with this technique is that it involves a two-phase addition polymerization process since the mesophase is not miscible in the isotropic pitch from which it is made. Thus, when the size of the mesophase spheres formed in the isotropic pitch within the preform exceeds the size of the space they occupy, they are expelled and replaced with the isotropic pitch material which forms a lower quality matrix.

Instead of using proprietary temperature-pressure cycles to make mesophase pitch, it can be manufactured by the polymerization of naphthalene or other aromatic monomers. There are some patents dealing with polymerization of low-molecular-weight compounds into higher-molecular-weight carbon precursor materials. However, the majority of these patents (U.S. Pat. Nos. 4,590,055; 4,801,372; 4,861,653; 4,898,723; 5,030,435; 5,047,292; 5,091,072; 5,217,701; 5,238,672; and 5,308,599) deal only with the spinning of carbon fibers and do not make any claims regarding use of high-molecular-weight polymers as matrix material. There are a few patents (U.S. Pat. Nos. 4,986,943; 5,061,414; 5,217,657; 5,338,605; and 5,360,669) that describe processes for manufacturing C—C's which involve preparation of high-molecular-weight liquid matrix precursors from monomers. All of these patents describe how to impregnate with the liquid matrix-precursor (using, a variety of techniques) while in the form of high-molecular-weight materials only. The formation of high-molecular-weight liquid matrix-precursor takes place in all these patents outside the C—C composite prior to impregnation and attempts to force this high viscosity material into thick fiber preforms to produce a uniform density have not been successful.

An example of using mesophase pitch as a precursor is the patent of Kawakubo (U.S. Pat. No. 5,096,519) that teaches a process for mixing carbon fibers with a low-molecular-weight aromatic hydrocarbon (naphthalenes) and a molten salt such as aluminum chloride or potassium chloride as a catalyst to form a mesophase pitch which coats the fibers. Kawakubo describes a technique for coating individual carbon fibers that are pulled from a bath of mesophase pitch and are later used to make a one or two-dimensionally reinforced composite. His process does not require that the naphthalene wet the fibers. Since the mesophase powder formed from naphthalene is already coating the individual fibers, it does not have to be able to flow into the small matrix pockets of a woven or braided preform. Thus, in Kawakubo, any of the high char yield precursors mentioned previously would perform equally well. In addition Kawakubo requires that molding-to-shape of the coated fibers be performed prior to pyrolysis. The molecular weight of the mesophase pitch must therefore be kept relatively low, otherwise fiber breakage will take place seriously degrading composite properties as discussed previously. Certainly, ultra-high molecular weights are not feasible and as a result, it is not possible with the Kawakubo patent to obtain a char yield of 92% from naphthalene. Also, since Kawakubo teaches the coating of the fibers, the molding of the fibers, and the carbonization of the mesophase pitch but not the impregnation of a preform or the reimpregnation of a preform, the product of his patent is a low density composite with low performance.

A recent process for the densification of carbons is taught in Wapner's (U.S. Pat. Nos. 6,309,703 and 6,706,401) patents, both herein incorporated by reference, that utilizes naphthalene and a catalyst to perform the densification. The catalyst is a super lewis acid catalyst hydrogen fluoride/boron trifluoride (HF/BF₃) that promotes the development of a mesophase as the naphthalene decomposes. The mesophase pitch then polymerizes and hardens into a carbonizable and graphitizable carbon product. This method, unfortunately, requires a batch process since as the densification proceeds, the naphthalene in the furnace is consumed and converted to a carbon structure, thereby requiring not only a re-supply of the furnace after cool down, but a cleaning of the carbon residue in the furnace.

### SUMMARY OF THE INVENTION

Materials and methods to rapidly densify carbon-carbon composite preforms utilizing a continuous flow closed-loop liquid precursor, such as 1,2 methyl naphthalene, naphthalene, pitch, or mesophase pitch, is taught herein. Currently, naphthalenes and derivatives thereof are utilized to synthesize pitch and mesophase pitch precursors. These precursors are utilized widely in the fabrication of carbon fibers and carbon-carbon composites. By utilizing the precursor for the pitch precursor, (i.e. make the pitch precursor in-situ) while performing the densification of the carbon-carbon, a faster and cheaper process for densification is achieved. In this invention, preferably 1,2 methyl naphthalene is pressurized and forced through a carbon composite preform (a woven carbon structure or a carbon foam) in a continuous flow closed loop system. This carbon composite preform is heated during the process by at least one of several means, such as RF induction, microwave, electrical resistance, and radial conduction heating. Preferably the preform is heated to a temperature such that the 1,2 methyl naphthalene decomposes to a graphitizable carbon layer on the surfaces of the carbon preform. This temperature is roughly 350° C. The 1,2 methyl naphthalene may be treated with a catalyst such as hydrogen fluoride/boron triflouride (HF/BF₃) to promote development of a mesophase structure in the decomposition layer. This precursor fluid is then cooled and re-circulated (after filtering) with a pump to the carbon composite preform. Using this continuous method, there is no need to remove the part and machine a surface skin or perform several batch processes typical with carbon-carbon composite manufacturing. This method will continuously deposit the carbon layers until the structure is dense. This carbon structure can then be carbonized and graphitized producing a dense carbon-carbon composite in a short period of time, unlike the several weeks to months for typical processes which use batch processing.

### BRIEF DESCRIPTION OF THE DRAWINGS

FIG. 1 is a flow diagram of a prior art method for making carbon-carbon composites.

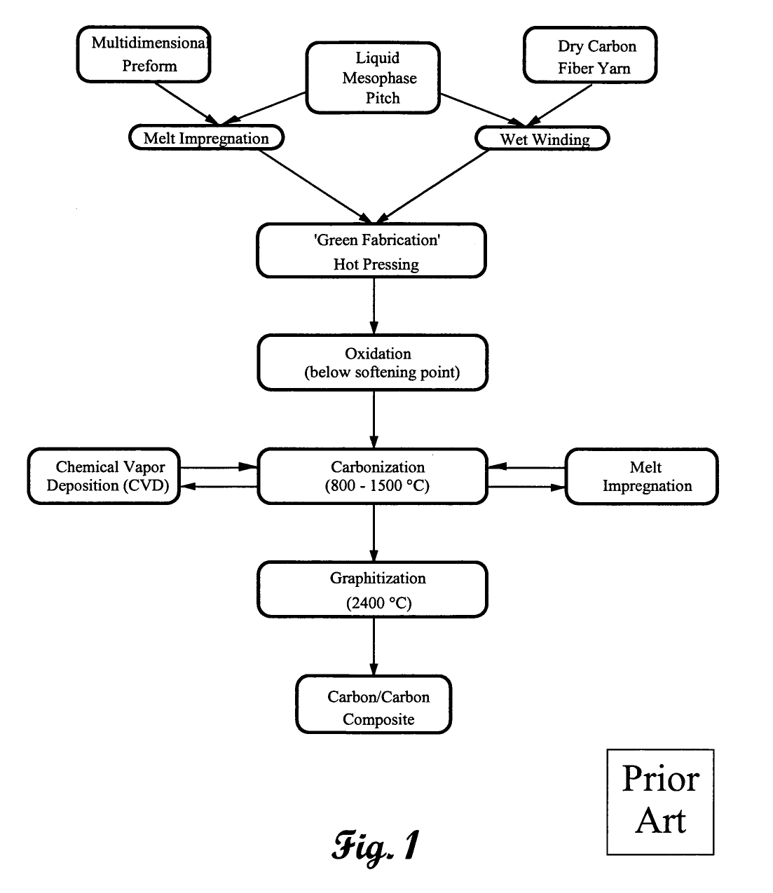

FIG. 2 is a schematic diagram of one embodiment of the invention with a fixed preform heating position.

FIG. 3 is a schematic diagram of another embodiment of the invention with a removable heating zone die.

### DETAILED DESCRIPTION OF THE PREFERRED EMBODIMENTS

This invention is a continuous process for the fabrication of carbon-carbon composites, and resulting materials, utilizing a liquid precursor. Other methods of densification utilize vapor phase densification, wherein the process proceeds at a relatively slow rate due to the limitation of the vapor diffusion through the pores. The instant invention utilizes a liquid precursor and, as such the process of densification proceeds at a more rapid pace than with vapor phase densification methods. Recent process improvements using liquid precursors teach batch processing routes for the densification phase. This requires frequent removal of the part from the furnace to machine a surface skin that develops or to re-supply the furnace with the liquid. As a batch process, this can still be a lengthy process.

This invention has overcome the need to perform the densification in a batch process, and teaches a continuous flow closed loop method and materials for impregnation such that the carbon preform is completely densified in one cycle.

This invention is a method to continuously impregnate a carbon composite preform with liquid mesophase pitch and simultaneously expunge the reaction by-products into the flowing liquid thereby exposing preform surfaces to recirculated liquid pitch.

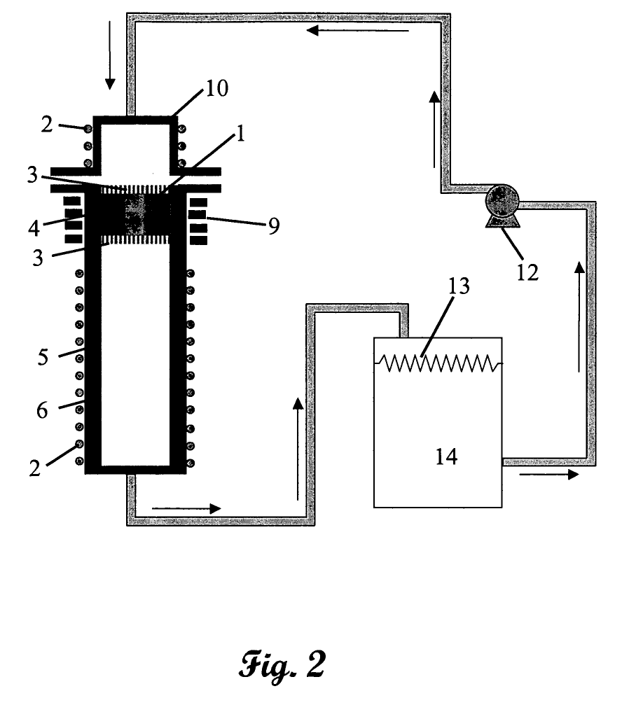

An example schematic of the system is shown in FIG. 2. In this example, the carbon composite preform 1 is placed in a sleeve 4 and inserted into the reaction chamber 6. In this case we have illustrated a cylinder, but the preform 1 can be almost any shape. A perforated plate 3 on one end of the preform 1 restrains the preform from moving and a perforated plate 3 is placed on the other side of the preform 1 to completely restrain the movement of the preform 1. The reaction chamber 6 is connected to the chamber lid 10 and the preform is heated with one (or several) means for heating 9 such as normal radial conduction heating radio frequency (RF) induction, electrical resistive heating (passing a current directly through the part), or microwave heating. Optional cooling coils 2 chill portions of the reaction chamber 6 not directly surrounding the preform 1 to be densified, thereby cooling the circulating liquid precursor 14 used for the densification process. In the most preferable case, 1,2 methyl naphthalene is utilized as the densification precursor 14 since it has a melting point below room temperature and is stable at elevated temperatures to the point of decomposition (around 350° C.). A circulating pump 12 is used to pressurize the precursor 14 and force the precursor 14 through the pores of the carbon composite preform 1. As the precursor 14 passes over the hot filaments or surfaces in the preform 1, it is catalyzed by a catalyst and produces a liquid crystal mesophase pitch. This pitch then begins to polymerize and harden into a rigid carbon part impregnated with pitch which can then be subsequently carbonized and graphitized to produce a graphitic structure. As the fluid precursor 14 is decomposed, the decomposition products which do not convert to a mesophase pitch and condense on the composite preform 1 are expelled from the composite preform 1 by the pressurized clean precursor 14 entering the preform 1. The precursor 14 is then immediately cooled by cooling coils 2 as it exits the preform 1 to stop decomposition of the precursor 14 fluid. The precursor 14 is then sent to a reservoir for filtering 13 and recirculation back to the reaction chamber 6 for further densification.

The system, depending on the heating method, will be most efficient if the part is heated radially from the exterior of the system to the interior. In this case, there will be a thin region which is at the proper temperature to induce decomposition of the fluid, thereby reducing pressure drop and allowing a faster deposition. An advantage of this method is that even if the deposition process is not uniform, as the part is densified and pressure builds up, the fluid will take the path of least resistance, thereby flowing naturally to the regions which have not been densified. Hence, the part will be homogeneously densified as the process continues to completion.

The process will proceed until a desired back pressure on the clean fluid entering the system reaches a pre-determined level, for example 20 psi. The process yields a dense carbon structure which, when carbonized and graphitized, will yield a highly graphitic carbon-carbon composite.

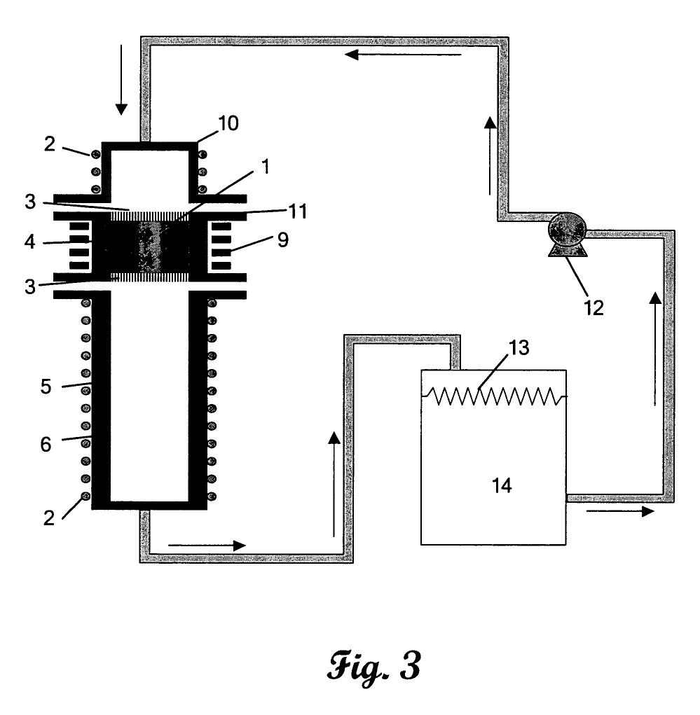

It will be obvious to others in the art that many variations of this can be successfully implemented. For example, different precursors can be utilized with varying melting points, such as naphthalene, methyl naphthalene, anthracene, mesophase pitch, isotropic pitch, petroleum pitches, synthetic pitches, or pitches from coal that can be mixed with at least one catalyst such as hydrogen fluoride/boron triflouride, aluminum chloride, and potassium chloride. Also, different geometries of the reaction chamber can be utilized, as in FIG. 3. In this example, the preform 1 is inserted into a heating zone die 11 which completely separates from the chamber 6 to facilitate removal of the part once densified. In this case, the densified part can simply be pressed out of its sleeve once removed from the system after the process in complete.

The basis of this invention is that a carbon composite preform is heated, a liquid precursor is continuously passed through the part where it is decomposed (with or without a catalyst) and the carbon deposit forms on the surfaces of the preform thereby impregnating the preform. The decomposition fluids are expelled from the composite preform as the new fresh precursor fluids are forced into the preform. It is a unique aspect of this invention that as the preform becomes densified, the pressurized precursor fluid will take the path of least resistance, thereby flowing to the undensified regions and yielding a very homogeneous part.

While there has been shown and described what are at present considered the preferred embodiments of the invention, it will be obvious to those skilled in the art that various changes and modifications can be made therein without departing from the scope.

We claim:

1. A method of manufacturing a carbon-carbon composite material of essentially uniform density comprising the steps:
(a) heating a carbon preform using a means for heating;
(b) providing a liquid phase precursor;
(c) impregnating said carbon preform with said precursor using continuously recirculating closed-loop flow of said precursor.

2. The method of claim 1 wherein said preform is selected from the group consisting of woven carbon structure and carbon foam.

3. The method of claim 1 wherein said means for heating is selected from at least one of the group consisting of normal radial conduction, RF induction, microwave, and electrical resistance.

4. The method of claim 1 wherein said liquid phase precursor is in a decomposed condensed phase.

5. The method of claim 1 wherein said liquid phase precursor is selected from at least one of the group consisting of naphthalene, methyl naphthalene, anthracene, mesophase pitch, isotropic pitch, petroleum pitches, synthetic pitches, pitches from coal, and catalysts.

6. The method of claim 5 wherein said catalyst is selected from at least one of the group consisting of hydrogen fluoride/boron triflouride mixture, aluminum chloride, and potassium chloride.

7. The method of claim 1 further comprising at least one of the steps selected from the group consisting of: cooling said precursor when not impregnating, carbonizing said preform after impregnating, graphitizing said preform after impregnating, and filtering said precursor.

8. A carbon composite material of essentially uniform density fabricated by the steps of:
(a) heating a carbon preform using a means for heating;
(b) providing a liquid phase precursor;
(c) impregnating said carbon preform with said precursor using continuously recirculating closed-loop flow of said precursor.

9. The material of claim 8 wherein said preform is selected from the group consisting of woven carbon structure and carbon foam.

10. The material of claim 8 wherein said means for heating is selected from at least one of the group consisting of normal radial conduction, RF induction, microwave, and electrical resistance.

11. The material of claim 8 wherein said liquid phase precursor is in a decomposed condensed phase.

12. The material of claim 8 wherein said liquid phase precursor is selected from at least one of the group consisting of naphthalene, methyl naphthalene, anthracene, mesophase pitch, isotropic pitch, petroleum pitches, synthetic pitches, pitches from coal, and catalysts.

13. The method of claim 12 wherein said catalyst is selected from at least one of the group consisting of hydrogen fluoride/boron triflouride mixture, aluminum chloride, and potassium chloride.

14. The method of claim 8 further comprising at least one of the steps selected from the group consisting of: cooling said precursor when not impregnating, carbonizing said preform after impregnating, graphitizing said preform after impregnating, and filtering said precursor.
